(19) United States
(12) Patent Application Publication
(10) Pub. No.: US 2017/0330231 A1
(43) Pub. Date: Nov. 16, 2017

(54) METHOD AND SYSTEM TO DISPLAY TARGETED ADS BASED ON RANKING OUTPUT OF TRANSACTIONS

(71) Applicant: LTRAC LLC dba ProspectNow, Los Altos, CA (US)

(72) Inventors: Steven S. WAYNE, Los Altos, CA (US); Sachindev SHETTY, San Francisco, CA (US)

(21) Appl. No.: 15/590,967

(22) Filed: May 9, 2017

Related U.S. Application Data
(60) Provisional application No. 62/334,350, filed on May 10, 2016.
(60) Provisional application No. 62/347,027, filed on Jun. 7, 2016.

(51) Int. Cl. G06Q 30/02; G06F 17/30; G06N 99/00; G06Q 50/16

(52) U.S. Cl. CPC G06Q 30/0254; G06Q 50/165; G06F 17/3053; G06N 99/005

(57) ABSTRACT

Computer-implemented method and system to display targeted ads based on ranking output of transactions. The computer-implemented method includes ranking likely sellers of real estate. Further, the computer-implemented method includes ranking likely refinances or loans on real estate. Furthermore, the computer-implemented method includes matching visitors of websites to properties in a property database that includes owner details and property details. Moreover, the computer-implemented method includes displaying most relevant ads to users based on rank of property owned.

### TECHNICAL FIELD

Embodiments of the disclosure relate generally to advertisements. Embodiments relate more particularly to display targeted ads based on ranking output of transactions.

### BACKGROUND

Mortgage companies, banks and real estate companies are spending money on marketing to property owners that have no intention of refinancing, selling, or obtaining a loan on their property.

Most display ads are just using user contributed profile data, not the underlying information on the real estate the user owns. Hence, we can display ads from advertisers including, but not limited to banks, real estate lenders, and real estate brokerages to property owners much more likely to require the services of the advertisers.

In the light of the above discussion, there appears to be a need for using a machine learning model that takes the user's real estate owned, combines with relevant economic and social data as inputs as inputs to determine which properties are most likely to require the products and services of the advertisers and display the most targeted digital ads to them.

### OBJECT OF INVENTION

The principal object of the embodiments herein is to that rank properties on the likelihood of a transaction occurring (typically a refinance, line of credit, purchase loan or property sale) in the next 12 months and then leverages ranking output from the model to display the most targeted ads to website/app users.

Another object of the embodiments herein is to reduce wasteful marketing spend and enables these marketers or advertisers to target their expenditure on more probably candidates for their services.

Another object of the embodiments herein is to analyze the real estate taking inputs from multiple fields and uses a machine learning model that ranks properties that are more likely to refinance, obtain a loan, or sell. The ranking is then used to display targeted advertising to user(s) of a web application based on the rank of the property they own.

### SUMMARY

The above-mentioned needs are met by a computer-implemented method, computer-program product and system to display targeted ads based on ranking output of transactions.

An example of a computer-implemented method to display targeted ads based on ranking output of transactions includes fetching data from a plurality of resources, the data includes properties, social data and other economic data. Further, the computer-implemented method includes ranking the properties on the likelihood of a transaction by the machine learning model. Furthermore, the computer-implemented method includes retrieving the rank associated to a specific property by matching a user profile to the user's property through a ranking model. Moreover, the computer-implemented method includes displaying most relevant ads from one of a bank and a mortgage broker based on the rank, wherein the rank suggests if the user is likely to refinance the property in near future.

An example of a computer-program product to display targeted ads based on ranking output of transactions includes fetching data from a plurality of resources, the data includes properties, social data and other economic data. Further, the computer-program product includes ranking the properties on the likelihood of a transaction by the machine learning model. Furthermore, the computer-program product includes retrieving the rank associated to a specific property by matching a user profile to the user's property through a ranking model. Moreover, the computer-program product includes displaying most relevant ads from one of a bank and a mortgage broker based on the rank, wherein the rank suggests if the user is likely to refinance the property in near future.

An example of a system to display targeted ads based on ranking output of transactions includes a computing device operated by a user through a user interface, wherein the computing device is constantly updated with real estate transactions. Further, the system includes a property database to store owner and property details. Furthermore, the system includes a processor configured within the computing device and operable to perform: fetch data from a plurality of resources, the data includes properties, social data and other economic data; rank the properties on the likelihood of a transaction by the machine learning model; retrieve the rank associated to a specific property by matching a user profile to the user's property through a ranking model; display most relevant ads from one of a bank and a mortgage broker based on the rank, wherein the rank suggests if the user is likely to refinance the property in near future.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the present disclosure.

FIG. 1 is a block diagram of an environment, according to the embodiments as disclosed herein;

FIG. 2 illustrates an exemplary table for all refinance events happening for the previous two years, according to the embodiments as disclosed herein;

FIG. 3 illustrates an exemplary table performance for residential (SF countries), according to the embodiments as disclosed herein;

FIG. 4 illustrates an exemplary table performance for commercial (SF Countries), according to the embodiments as disclosed herein;

FIG. 5 illustrates exemplary table performances for residential and commercial, according to the embodiments as disclosed herein;

FIG. 6 is a flow diagram describing a method to display targeted ads based on ranking output of transactions, according to the embodiments as disclosed herein; and

FIG. 7 is a block diagram of a machine in the example form of a computer system within which instructions for causing the machine to perform any one or more of the methodologies discussed herein may be executed.

### DETAILED DESCRIPTION OF THE EMBODIMENTS

The above-mentioned needs are met by a computer-implemented method and system to display targeted ads based on ranking output of transactions. The following detailed description is intended to provide example implementations to one of ordinary skill in the art, and is not intended to limit the invention to the explicit disclosure, as one of ordinary skill in the art will understand that variations can be substituted that are within the scope of the invention as described.

The invention uses a machine learning model that analyzes virtually every property in the US. As transactions occur, the model analyzes properties that have refinanced or sold and also takes treasury rates, social data, other economic data and then ranks properties that have yet to refinance or sell on the likelihood they will refinance or sell in the near future. This data is then cross referenced to a the web app user's profile and ads are displayed to the users that are highly targeted.

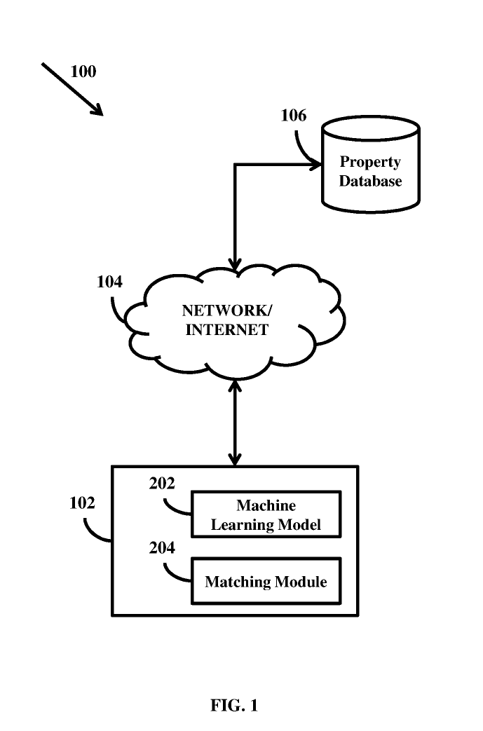

FIG. 1 is a block diagram of an environment, according to the embodiments as disclosed herein. The environment 100 includes a computing device 102, a network 104 and a property database 106. The computing device 102 further includes a machine learning model 202 and a matching module 204.

The computing device 102 is a portable electronic or a desktop device configured with a user interface (not shown in FIG. 1) to interact with a user. Examples of the computing device 102 include, but are not limited to, a personal computer (PC), a mobile phone, a tablet device, a personal digital assistant (PDA), a smart phone and a laptop. Examples of the user interface include, but are not limited to, display screen, keyboard, mouse, light pen, appearance of a desktop, illuminated characters and help messages.

The computing device 102 is constantly fed with real estate transactions that include several fields. Examples of fields include, but are not limited to, loan amount, last loan date, property type, last sale date, owner data, owner status, economic data, treasury rates and social data. Typically, the computing device 102 is designed to accept any property or owner related data to determine which fields are predictive. Further, the real estate transactions are fed through a ranking model.

The computing device 102 is configured with a computer program product. The computer program product also includes instructions that when executed perform the method described herein. Typically, the method works on a logic that is based on the field inputs from the real estate and the owner for transactions that have taken place.

Typically, the machine learning model 202 is used for ranking likely sellers of real estate and ranking refinances or loans on real estate. The machine learning model 202 ranks properties on the likelihood of a transaction occurring in the next 12 months and then leverages a ranking output from the model to display the most targeted ads to website/app users. Examples of properties include, but are not limited to, a single-family home, a condo, an apartment building, a commercial property and an industrial property.

The matching module 204 utilizes a matching algorithm for visitors of website to properties in the property database 206. Further, an Ad matching algorithm is also employed to display the most relevant ads to users based on rank of property owned.

Network link(s) involved in the system of the present invention may include any suitable number or arrangement of interconnected networks including both wired and wireless networks. By way of example, a wireless communication network link over which mobile devices communicate may utilize a cellular-based communication infrastructure. The communication infrastructure includes cellular-based communication protocols such as AMPS, CDMA, TDMA, GSM (Global System for Mobile communications), iDEN, GPRS, EDGE (Enhanced Data rates for GSM Evolution), UMTS (Universal Mobile Telecommunications System), WCDMA and their variants, among others. In various embodiments, network link may further include, or alternately include, a variety of communication channels and networks such as WLAN/Wi-Fi, WiMAX, Wide Area Networks (WANs), and Blue-Tooth.

The property database 106 stores owner and property details.

The properties are first ranked by the machine learning model, based on the likelihood of a transaction (usually a refinance or sale of the property). Subsequently, the matching algorithm is employed to match an Internet user the real estate that he/she owns. The rank (along with associated probability) is retrieved to identify if a specific online advertisement can be displayed using the Ad matching algorithm. The result is a visitor to a given website will be served ads from lenders, mortgage companies, real estate brokerage companies or other related entities that are incredibly targeted. The targeting is based on the real estate owned and the associated rank determined by the machine learning model.

It should be appreciated to those of ordinary skill in the art that FIG. 1 depicts the computing in an oversimplified manner and a practical embodiment may include additional components and suitably configured processing logic to support known or conventional operating features that are not described in detail herein.

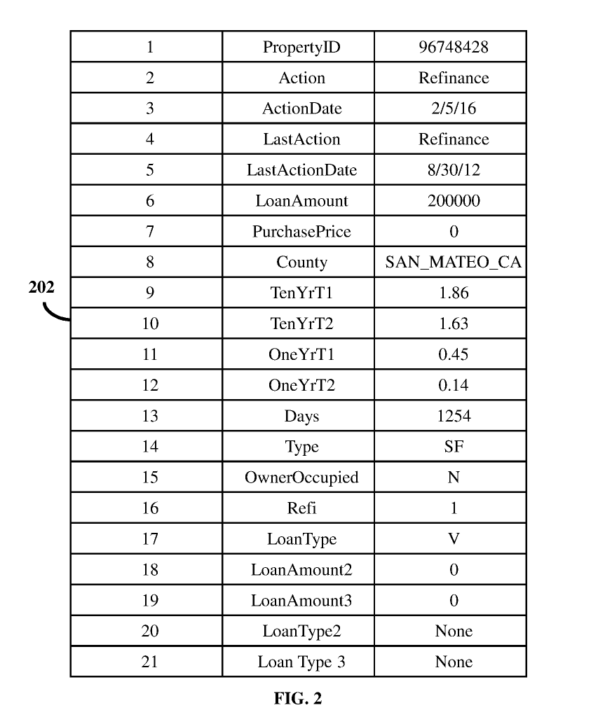

FIG. 2 illustrates an exemplary table for all refinance events happening for the previous two years, according to the embodiments as disclosed herein. The table (data frame structure) 202 illustrates all refinance events happening for the previous two years.

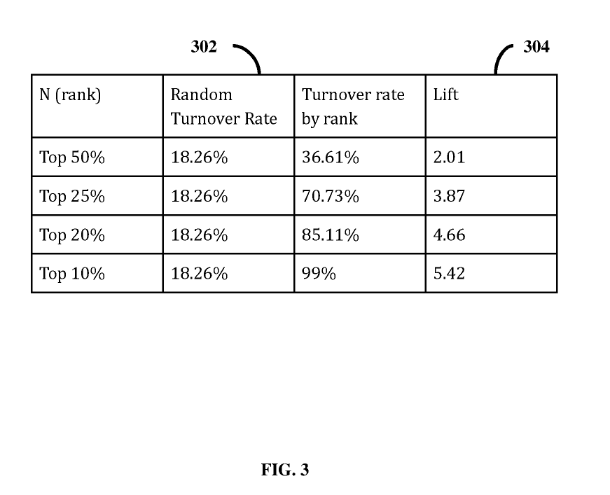

FIG. 3 illustrates an exemplary table performance for residential (SF countries), according to the embodiments as disclosed herein. The table 302 captures the improvement in performance over two years of data for commercial and residential for the prediction of a refinance or loan transaction. The lift results column 304 clearly indicates a dramatic increase in probability of a refinance in properties with higher ranks.

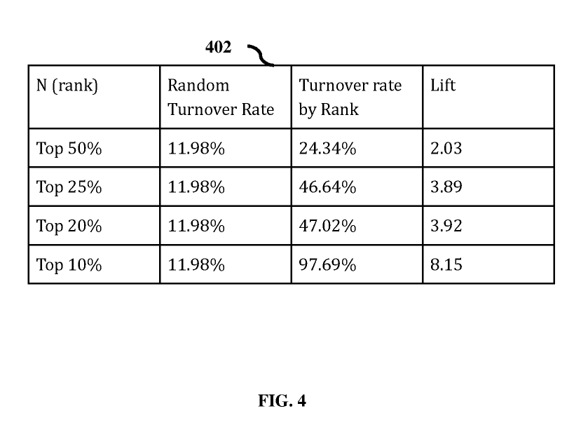

FIG. 4 illustrates an exemplary table 402 performance for commercial (SF Countries), according to the embodiments as disclosed herein.

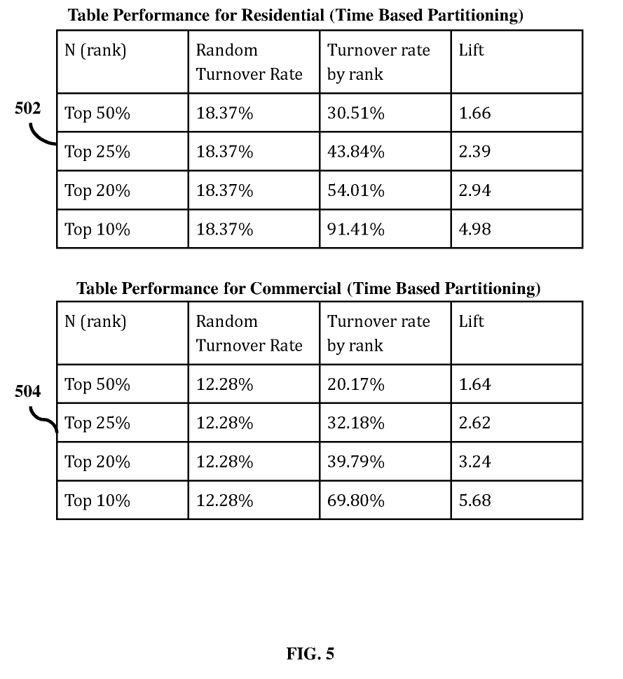

FIG. 5 illustrates exemplary table performances for residential 502 and commercial 504, according to the embodiments as disclosed herein. The table performances are time based partitioning.

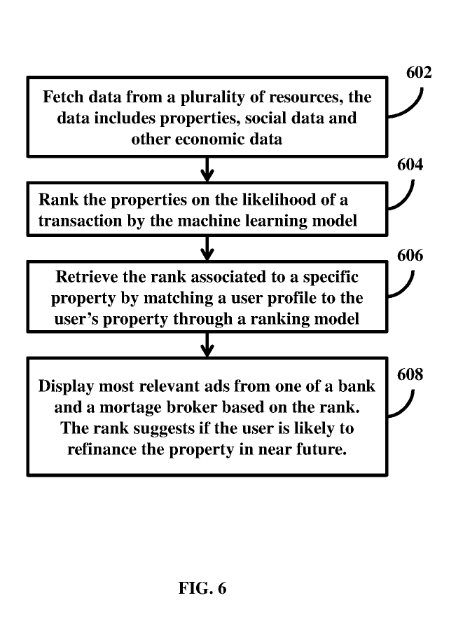

FIG. 6 is a flow diagram describing a method to display targeted ads based on ranking output of transactions, according to the embodiments as disclosed herein. The flow diagram begins at step 602.

The objective is to identify the property that the website visitor or app user owns. In some cases this address will be part of their profile and we are doing a match against that. In other cases we may use geolocation to determine the address. Once the address is obtained, then we match it to our database to determine the refi/seller probability ranking.

For instance, consider a user logged in to Google mail/Google+/Yahoo mail/Facebook and other sites. In this case, the user's address is usually known and provided by the user. In other cases, a number of factors could be used to determine the property address of the user. For example IP address and device location along with user name could be enough to match with our database. GPS/Wi-FI to get property address could also be used. Additionally, the ranked property owners may be matched to user cookie profiles and other 3^{rd} party data sets to determine the visitor's real estate owned and subsequent ranking from the database.

At step 602, data is fetched from a plurality of resources. The data includes properties social data and other economic data;

At step 604, the properties are ranked on the likelihood of a transaction by the machine learning model.

Typically, the rank (and associated probability) is retrieved to identify if a specific online advertisement can be displayed using the Ad matching algorithm.

A rank is applied to virtually every property, and then this is retrieved by matching the user profile to the user's property and retrieving the rank. If the rank suggests the user is most likely to refinance his/her property in the near term, the an ad is displayed from a bank or mortgage broker. For example, If the rank suggest the user is a good candidate for a 30 year fixed loan, the related ad is displayed.

The ranking model has a feedback loop which takes into account every refinance or sale that has occurred since the last update to modify ranks to include more recent trends. This loop constantly updates and improves the ranking. Once a ranking algorithm is in place this information would then be used to match against website user's profiles to display the most relevant ads.

The property data and ranking process are required. Also a website that has profile data that includes the user's home address so the rank of the user's property can be retrieved.

For each individual property that has been sold or refinanced, a snapshot of all the relevant details prior to the transaction occurring is captured. Consequently, each distinct property is represented by a time series. For instance, fields such as the holding period, loan origination date, loan amount along with information such as the loan type, economic data, property type, social relevant information such as marital status, age of the property owner when he bought/sold property or when he did a refinance or a particular loan. A transaction prediction model is designed to accept and analyze different fields of data on a property to determine their correlation to the probability of a transaction event. This gives it the flexibility to continue to learn.

Below is a brief description of how the time series data model is captured and used for commercial and residential mortgage refinance model from one of our SQL tables.

### Example: County San Mateo (SQL Query for Pulling Refi Data)

### Select

property_id, buyer, seller, record_type, loan amount, lender, loan_amount_second, loan_amount_third, financing_type, financing_type_2, financing_type_3, purchase_price, date_purchased from property_resi_history_SAN_MATEO_CA

A refinance event from this table is defined as follows:

Record_type=‘L’ and (loanamount>0 or loan_amound_second>0 or loan_amount_third>0)

For all refinance events happening for the previous 2 years, data frame structure is created (example shown in FIG. 2).

Property ID of property

### Action—Refinance

### Date of Refinance

Last Action (either Sale or Refinance)

### Last Action Date

### Loan Amount in $

Purchase Price if last Action was Sale

### County

### Ten Year Treasury at Date of Refinance

### Ten Year Treasury at Last Action Date

### One Year Treasury at Date of Refinance

### One Year Treasury at Last Action Date

Days between the Date of Refinance and Last Action Date

### Type of Property (Single Family, Multi-Family, Commercial or Industrial)

### Owner Occupied (Y/N)

### Refi=1 (or 0)

### Loan Type (Variable, Fixed or Unknown)

### Loan Amount (Second Loan) in $

### Loan Amount (Third Loan) in $

### Loan Type of Second Loan

### Loan Type of Third Loan

Social information for buyer seller is also appended so that information for marital status/age/Location could be appended to the data frame along with other relevant financial/economic data. The relevant training data is then used by a machine learning model to predict the likelihood of a future sale or refinance given the current state of the property

The actual machine learning model is decided on performance (precision/recall metrics) on the test set which is the most recent month (or couple of months of data) of refinance or sale data. The model could be but not limited to a neural network or a boosted decision tree, random forest or a simple logistic regression. In addition the machine learning model could be a stacked/ensemble combination of several learning models.

For reaching higher performance and convergence of models we may potentially bin the training & test data. For example:
Days between Refi Date and Last Sale/Refinance date is binned into intervals of 360 days
Loan Amount (& Loan Amount 2 and Loan Amount 3) are binned into different bins based on residential or commercial distributions in our training/test data sets
All null Loan Types are mapped to ‘None’ if corresponding Loan Amount is zero else mapped to ‘U’

Below is a list that is currently implemented based on loan amount distribution bins used in our predictive machine learning model.

Loan Amount Bins for Commercial

### Bin 1 $0<Loan Amount <$250,000

### Bin 2 $250,000<=Loan Amount <$500,000

. . .
. . .

### Bin 20 $4,750,000<=Loan Amount <$5,000,000

### Bin 21 $5,000,000<=Loan Amount

Loan Amount Bins for Residential

### Bin 1 $0<Loan Amount <$100,000

### Bin 2 $100,000<=Loan Amount <$200,000

. . .
. . .
. . .

### Bin 10 $900,000<=Loan Amount <$1,000,000

### Bin 11 $1,000,000<=Loan Amount

The following are the relative influence of the features ranked in importance for the commercial model:

The above data frame is then joined with other data sets to extract data such as treasury rates, social and finance data which is used in the machine learning model.

The current state for each property is required to make predictions (probability) for sale or refinance. In terms of performance we evaluate by partitioning data into a training set and a test set. A commonly used criteria for the training set is ˜2 years of sales/refinance data and that for the test set could be the last 3 months of data.

We then evaluate Lift in terms of % refinances captured by random targeting of N % of population vs precision targeting of top N % and determine the machine learning model that gives us the best lift.

The tables illustrated in FIG. 3 and FIG. 4 capture the improvement in performance (Recall) over 2 years of data for commercial and residential for the prediction of a refinance or loan transaction. The lift results clearly indicate a dramatic increase in probability of a refinance in properties with higher ranks.

### Back Testing Results Using Time Based Partitions of Refinance

Training Data=all refinances that occurred from Mar. 1 2014 through July 2015
Test Data=all refinances that occurred from August 2015 through February 2016
The results are shown as illustrated in FIG. 5.

At step 606, the rank associated to a specific property is retrieved by matching a user profile to the user's property through a ranking model

At step 608, displaying most relevant ads from one of a bank and a mortgage broker based on the rank, wherein the rank suggests if the user is likely to refinance the property in near future.

A user to a given website will be served ads from lenders, mortgage companies, real estate brokerage companies, or other related entities that are incredibly targeted. This targeting is based on the real estate they own and the associated rank determined by the machine learning model.

The Ad matching algorithm relates to the ranking of the property for the transaction type. Specifically, if a property has a high rank for being likely to refinance in the next 12 months, then an Ad is displayed from a mortgage company or lender. If the property has a high rank for being likely to sell, then we would display an ad for a real estate agent or other services that relate to a sale transaction.

Each advertiser-user combination would have a probability score indicating propensity to refinance or sell. The score would be using several factors/features and not limited to just the property. So if two financial institutions are targeting people for mortgage refinance features to include the score could include the geo-location of the financial institution, the CPL amount (Cost per Lead) as well as factors that influence a property from being refinanced or sold.

A company that has a website, mobile app, or software where their user's profile contains the user's home address would be able to use the invention. When a user visits the website, the system would query the ranking from the matching property. If the ranking returned indicates this property has a higher probability of refinancing, then an ad would be displayed on the website to the user from a vendor (typically a bank or mortgage company) that would provide access to these services to the user.

The flow diagram ends at step 608.

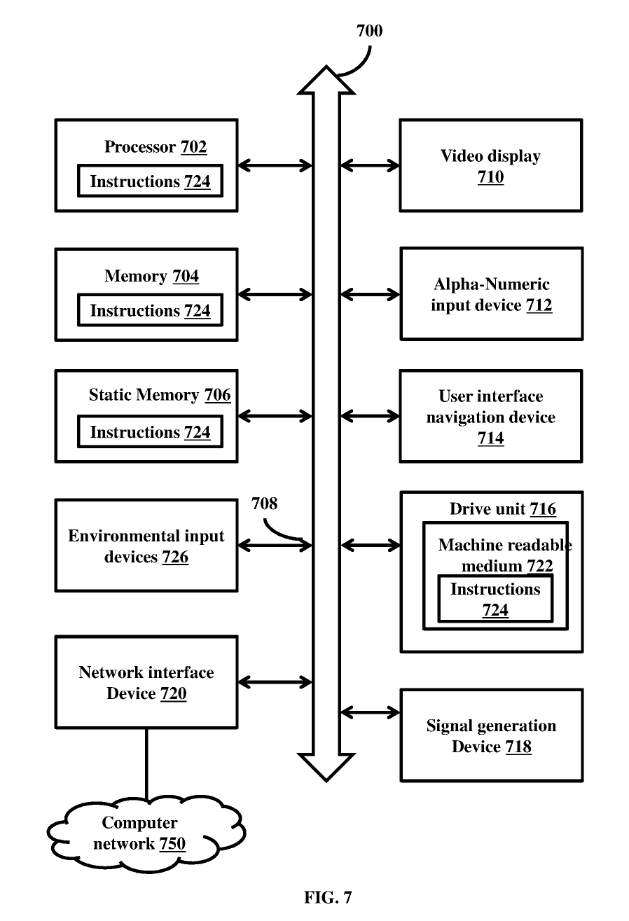

FIG. 7 is a block diagram of a machine in the example form of a computer system within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704, and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device 714 (e.g., a mouse), a disk drive unit 716, a signal generation device 718 (e.g., a speaker), and a network interface device 720. The computer system 700 may also include a environmental input device 726 that may provide a number of inputs describing the environment in which the computer system 700 or another device exists, including, but not limited to, any of a Global Positioning Sensing (GPS) receiver, a temperature sensor, a light sensor, a still photo or video camera, an audio sensor (e.g., a microphone), a velocity sensor, a gyroscope, an accelerometer, and a compass.

### Machine-Readable Medium

The disk drive unit 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more instructions 724 or data structures. The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

### Transmission Medium

The instructions 724 may further be transmitted or received over a computer network 750 using a transmission medium. The instructions 724 may be transmitted using the network interface device 720 and any one of a number of well-known transfer protocols (e.g., HTTP). Examples of communication networks include a local area network (LAN), a wide area network (WAN), the Internet, mobile telephone networks, Plain Old Telephone Service (POTS) networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible media to facilitate communication of such software.

As described herein, computer software products can be written in any of various suitable programming languages, such as C, C++, C#, Pascal, Fortran, Perl, Matlab (from MathWorks), SAS, SPSS, JavaScript, AJAX, and Java. The computer software product can be an independent application with data input and data display modules. Alternatively, the computer software products can be classes that can be instantiated as distributed objects. The computer software products can also be component software, for example Java Beans or Enterprise Java Beans. Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standard 802.11 including its substandards a, b, e, g, h, i, n, et al.). In one example, signals from the computer can be transferred, at least in part, wirelessly to components or other computers.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

1. A computer-implemented method for displaying targeted ads based on ranking output of transactions, the computer-implemented method comprising:
fetching data from a plurality of resources, the data includes properties, social data and other economic data;
ranking the properties on the likelihood of a transaction by the machine learning model;
retrieving the rank associated to a specific property by matching a user profile to the user's property through a ranking model; and
displaying most relevant ads from one of a bank and a mortgage broker based on the rank, wherein the rank suggests if the user is likely to refinance the property in near future.

2. The computer-implemented method of claim 1 and further comprising:
analyzing a plurality of fields from the data on a property to determine correlation of the fields to the probability of a transaction event through a machine learning model.

3. The computer-implemented method of claim 1 wherein ranking the data further comprises:
ranking likely sellers and refinances of real estate.

4. The computer-implemented method of claim 1 and further comprising:
storing the data in a property database; and
updating the property database constantly with real estate transactions, wherein the real estate transactions act as input data to the machine learning model.

5. The computer-implemented method of claim 1 wherein the ranking is retrieved to identify one or more specific advertisements that are later displayed to the user.

6. The computer-implemented method of claim 1 and further comprises:
modifying ranks after every occurrence of property sale through a feedback loop configured with the ranking model.

7. The computer-implemented method of claim 6 wherein the feedback loop constantly updates and improves the ranking of properties.

8. The computer-implemented method of claim 1 and further comprising:
matching visitors of web sites to properties in a property database that includes owner details and property details; and
predicting the likelihood of one of a future sale and refinance for a given state of the property.

9. A computer program product stored on a non-transitory computer-readable medium that when executed by a processor, performs a method for displaying targeted ads based on ranking output of transactions, the computer program product comprising:
fetching data from a plurality of resources, the data includes properties, social data and other economic data;
ranking the properties on the likelihood of a transaction by the machine learning model;
retrieving the rank associated to a specific property by matching a user profile to the user's property through a ranking model;
displaying most relevant ads from one of a bank and a mortgage broker based on the rank, wherein the rank suggests if the user is likely to refinance the property in near future.

10. The computer program product of claim 9 and further comprising:
analyzing a plurality of fields from the data on a property to determine correlation of the fields to the probability of a transaction event through a machine learning model.

11. The computer program product of claim 9 wherein ranking the data further comprises:
ranking likely sellers and refinances of real estate.

12. The computer program product of claim 9 and further comprising:
storing the data in a property database; and
updating the property database constantly with real estate transactions, wherein the real estate transactions act as input data to the machine learning model.

13. The computer program product of claim 9 wherein the ranking is retrieved to identify one or more specific advertisements that are later displayed to the user.

14. The computer program product of claim 9 and further comprises:
modifying ranks after every occurrence of property sale through a feedback loop configured with the ranking model.

15. The computer program product of claim 14 wherein the feedback loop constantly updates and improves the ranking of properties.

16. The computer program product of claim 9 and further comprising:
matching visitors of web sites to properties in a property database that includes owner details and property details; and
predicting the likelihood of one of a future sale and refinance for a given state of the property.

17. A system for displaying targeted ads based on ranking output of transactions, the system comprising:
a computing device operated by a user through a user interface, wherein the computing device is constantly updated with real estate transactions;
a property database to store owner and property details; and
a processor configured within the computing device and operable to perform:
fetch data from a plurality of resources, the data includes properties, social data and other economic data;
rank the properties on the likelihood of a transaction by the machine learning model;
retrieve the rank associated to a specific property by matching a user profile to the user's property through a ranking model;
display most relevant ads from one of a bank and a mortgage broker based on the rank, wherein the rank suggests if the user is likely to refinance the property in near future.

18. The system of claim 17 wherein the real estate transactions are fed through a ranking model.

19. The system of claim 17 wherein the computing device is further configured with an Ad matching algorithm to display most relevant ads to the users based on the rank of property owned.

20. The system of claim 17 wherein the computing device further comprises:
a machine learning model to rank likely sellers of real estate and ranking refinances and loans on real estate;
a matching module configured with a matching algorithm for users of web sites to properties in the property database.
